(19) United States
(12) Patent Application Publication
(10) Pub. No.: US 2016/0177168 A1
(43) Pub. Date: Jun. 23, 2016

(54) COMPOSITION AND METHOD FOR REMOVING PIPE DOPE

(71) Applicant: SCHLUMBERGER TECHNOLOGY CORPORATION, Sugar Land, TX (US)

(72) Inventors: Samuel Danican, Sugar Land, TX (US); John W. Still, Katy, TX (US)

(21) Appl. No.: 14/573,199

(22) Filed: Dec. 17, 2014

(51) Int. Cl. C09K 8/52; E21B 37/06

(52) U.S. Cl. CPC C09K 8/52; E21B 37/06

(57) ABSTRACT

A composition is described as including a mixture of citrus terpene hydrocarbons and an alcohol ethoxylate. The alcohol ethoxylate is represented by the formula R(C₂H₄O)ₙOH, where R is a branched or linear alkyl chain having from 12 to 15 carbons, and n is from 3 to 14. A method of removing pipe dope from a wellbore surface is also described. The method involves contacting the wellbore surface with the composition, and circulating the composition with respect to the wellbore surface. The pipe dope detaches from the wellbore surface and is dispersed in the composition, facilitating its removal.

### BACKGROUND

The statements in this section merely provide background information related to the present disclosure and may not constitute prior art.

In the operation of an oil and gas well, production fluids are injected into the formation to create flow channels. As a result of the injection, water-in-oil emulsions may form at the interface between the injected aqueous treating solution and the crude oil contained in the formation. Solids and particulates then accumulate in the emulsions, plugging the pore space. The treating solution can also react with the crude oil, forming sludge that can further plug the pore space. Furthermore, excess pipe dope (also known as “thread compound” or “thread lubricant”) can escape from tubular surfaces of the well into the formation, plugging flow channels and pore space. The presence of these unwanted solids and particulates can reduce operation efficiency.

Pipe dope is a sealant that is applied to casing and tubing connections to provide sealability, galling resistance, and uniform frictional characteristics. For example, pipe dope can be applied to the wellbore casing and tubing in high pressure well service. In an oil well, the casing extends from the surface through a producing reservoir. The tubing is installed inside the casing to reach a producing zone. The casing and tubing are assembled at threaded connections. Application of the pipe dope may involve brushing or swabbing the pipe dope onto the surface of interest. Without sufficient application of pipe dope, the bearing stresses and heat created at points of contact would cause the connection to weld together. The joint would then eventually break down due to tearing of the weld under stress.

Pipe dope compositions are formulated to address several practical considerations. For example, the composition should be able to withstand temperatures up to 300° F. without disintegrating, undergoing radical change in volume, or becoming excessively fluid. The composition should also be resistant to water absorption, and should not contain fillers that will evaporate or oxidize, thereby changing the properties of the composition. Because pipe dope is designed to be stable at high pressures and temperatures, resistant to chemical degradation, and insoluble in water, its removal can be difficult. However, if the presence of excess pipe dope is not removed from the wellbore before operation of the well, the pipe dope may effectively seal off pore spaces in the formation. As used herein in the context of alleviating the presence of excess pipe dope, the term “remove” or “removing” also means to eliminate, minimize, or otherwise mitigate the presence of pipe dope on the surface to be treated.

Pipe dope may be comprised of grease, a silicone compound, powdered graphite, lead powder, zinc dust, and optionally copper. The metallic and graphite powders are uniformly dispersed in a base containing the grease and the silicone compound. Pipe dope is often a proprietary formulation, and the sealing properties of the pipe dope may depend upon the specific combination, particle sizes, and quantities of the powders dispersed in the grease base. For example, higher particulate concentrations result in a more viscous pipe dope, which helps create a seal. The grease base is also largely determinative of the final kinematic viscosity of the pipe dope. The presence of silicone compounds in the grease base improves low-temperature properties, and may also improve application to surfaces wet with water.

The presence of unwanted solids and particulates (e.g., sludge, excess pipe dope, asphaltenes, paraffins, etc.) can cause a restriction in pore openings in the formation, and thus reduction in the rate of oil and/or gas formation. Their presence can also block tubular and pipe equipment during production and surface processing. Thus, efficiency can be improved by removing these materials from the wellbore.

To do so, the well may be subjected to shut-in, whereby compositions are injected into the wellbore to remove the unwanted materials. These shut-ins are performed regularly, and involve downtime when no injection or production can take place.

Surfactants may be used for the displacement and removal of unwanted solids and particulates. However, their effectiveness is limited by solvency capacity, and surfactant systems can therefore be ineffective. For example, surfactant-based systems may be ineffective at breaking the emulsions formed at the interface of the treating solution and the crude oil and at effecting complete phase separation. Furthermore, aqueous surfactant-based treatments can create additional damage by actually forming an emulsion block with the formation oil. These emulsion blocks can potentially block production or injection. Additionally, such systems are often not biodegradable.

Organic solvents have a strong solvency toward unwanted solids and particulates such as excess pipe dope, and therefore can demonstrate greater success with removal and cleaning. However, pure organic solvent can be expensive, and thus cost prohibitive. Although water can be mixed with organic solvent to reduce the fluid cost, the effectiveness of the system can be greatly reduced, even at water-content levels as low as 10 to 20 vol %. Additionally, pure solvent may not be effective when the viscosity and solid content in the unwanted material are high. Pure organic solvents cannot effectively break up solid aggregation, and do not facilitate solid suspension. Furthermore, the solvents are often aromatic (such as xylene) and leave an environmental footprint. Thus, organic solvent alone is insufficient for separating unwanted solids and particulates from surfaces and removing them from inside the wellbore.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A composition and a methodology using the composition are provided for removing pipe dope from a surface of a wellbore. The composition includes 70 to 99 vol % citrus terpene hydrocarbons, and 1 to 30 vol % of an alcohol ethoxylate. The alcohol ethoxylate is represented by the formula R(C₂H₄O)ₙOH, where R is a branched or linear alkyl chain having from 12 to 15 carbons, and n is from 3 to 14. The methodology involves contacting the wellbore surface with an effective amount of the composition, and circulating the composition with respect to the surface so that at least a portion of the pipe dope detaches from the surface and is dispersed in the composition.

However, many modifications are possible without materially departing from the teachings of the detailed description. Accordingly, such modifications are intended to be included within the scope of the disclosure as defined in the claims.

### BRIEF DESCRIPTION OF THE DRAWINGS

Certain embodiments of the disclosure will hereafter be described with reference to the accompanying drawings. It should be understood, however, that the accompanying figures illustrate the various implementations described herein and are not meant to limit the scope of various technologies described herein.

FIGS. 1, 3, 5, and 7 are charts plotting the removal of pipe dope by different compositions as a function of weight percent over time.

FIGS. 2, 4, 6, and 8 are tables providing pictorial results of the efficacy of different compositions in removing pipe dope.

### DETAILED DESCRIPTION OF EMBODIMENTS

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if a specific data points within the range, or even no data points within the range, are explicitly identified or refer to a few specific, it is to be understood that inventors appreciate and understand that any conceivable data point within the range is to be considered to have been specified, and that inventors possessed knowledge of the entire range and each conceivable point and sub-range within the range.

As described herein, compositions are provided for separating unwanted solids and particulates from a surface. For example, the compositions can remove unwanted solids—such as pipe dope, asphaltenes, and paraffins—from within a wellbore. The compositions are capable of penetrating these unwanted solids such as excess pipe dope and lifting them from the surface for removal. In particular, the compositions have the ability to displace organic surfactants within the pipe dope that hold the pipe dope together, thereby releasing the solid fillers. The pipe dope is then dispersed in the composition for removal.

In one embodiment, the composition comprises terpene hydrocarbons and a non-ionic surfactant. The composition may be in the form of, for example, a solution or an emulsion. The non-ionic surfactant may be fully soluble in the terpene hydrocarbons. That is, the non-ionic surfactant may be capable of mixing with the terpene hydrocarbons in any proportion, forming a homogeneous solution. The homogeneous solution will be optically transparent, indicating that the surfactant and solvent are miscible. In instances where the composition is prepared for treatment of an oil and gas well, the composition may be prepared offsite by an approved supplier, and either remains stable over an extended period of time (for example, for more than 6 months), or can be easily rehomogenized.

The terpene hydrocarbons may be, for example, pine terpenes (derived from the resinous sap of pine trees); FC PRO XYLENE REPLACEMENT is a commercial product based on pine terpenes. The terpene hydrocarbons may also be citrus terpene hydrocarbons, which are terpenes found in citrus rind. For example, the terpene hydrocarbons may be d-limonene. MLB 161-11-02 is a commercial limonene product. Other terpene-based products may also be used if they have good solvency properties.

The non-ionic surfactant may be an alcohol ethoxylate surfactant, where the alcohol ethoxylate is represented by the formula R(C₂H₄O)ₙOH. In the formula, R is a branched or linear alkyl chain having, for example, 12 to 15 carbons. The degree of ethoxylation, represented by “n,” can be from 3 to 14. For example, the surfactant may include a branched alkyl chain having 13 carbons, and have a degree of ethoxylation of 5. TERRAVIS M5 (Sasol Chemicals (USA) LLC) is an example of such a surfactant. As the degree of ethoxylation (n) increases, the hydrophilicity of the surfactant increases. The degree of ethoxylation can therefore be adjusted so that the surfactant remains soluble in the solvent while maintaining sufficient hydrophobicity so as to interact with the material to be removed (for example, the pipe dope).

The composition may contain from 70 to 99 vol %, from 80 to 98 vol %, or from 90 to 95 vol % terpene hydrocarbons, and from 1 to 30 vol %, from 2 to 20 vol %, or from 5 to 10 vol % non-ionic surfactant. Additionally, the composition may be free of Priority Pollutants (EPA, Clean Water Act), drinking water contaminants (EPA, National Primary Drinking Water Regulations), Category 1A, 1B, and 2 CMR Agents (REACH), and alkyl phenol ethoxylates.

The composition can remain stable for several days without separation of the solvent and the surfactant. The stability of the composition is observable by its coloration, which remains transparent over extended periods of time. The stability of the composition is a function of the compatibility of the solvent and the surfactant.

Also disclosed herein is a method for separating unwanted solids and particulates from a surface. The method involves contacting the unwanted material (solids or particulates) deposited on a surface with any of the compositions set forth above containing terpene hydrocarbons and a non-ionic surfactant. Upon contact, the composition penetrates the material. The method may further include circulating the composition with respect to the surface so that the composition separates the material from the surface for removal, the material being dispersed in the composition. Additionally, the method may entail removing the composition containing the dispersed material, thereby removing the material from the proximity of the surface.

An additional embodiment includes a method of separating excess pipe dope from a surface of a wellbore. The method entails contacting the excess pipe dope with any of the compositions set forth above containing terpene hydrocarbons and a non-ionic surfactant. For example, a volume of the composition (e.g., 5 barrels) can be injected into the tubing of a wellbore, and then circulated down the tubing and up the annulus between the tubing and the casing. The composition can be circulated for a time period sufficient to remove the pipe dope from the tubing and casing surfaces, which will depend on the volume of the tubing. The treatment can be followed by or performed in conjunction with an acid treatment that removes scale, rust, or other contaminants previously covered by the pipe dope. A post-flush mixture can also be injected and circulated through the wellbore after treatment to ensure the tubing is free of debris.

During treatment, the composition may be pumped at a rate sufficient to generate turbulent flow to facilitate the separation of the excess pipe dope from the surfaces, such as 1 barrel/min or 2 barrels/min. If a volume of 5 barrels is pumped through the wellbore at a rate of 1 barrel/min, the treatment provides for 5 minutes of contact time between the composition and any given portion of the surface as the composition circulates down the tubing and up the annulus. If each of the tubing and the annulus has a volume of 180 barrels and the composition is pumped at a rate of 1 barrel/min, it would take 6 hours to complete the treatment. This time can be reduced to 3 hours by pumping the composition at a rate of 2 barrels/min.

The selection of pipe dope is not restricted. For example, the pipe dope may contain copper.

### EXAMPLES

It should be recognized that the examples below are provided to aid in an understanding of the present teachings. The examples should not be construed so as to limit the scope and application of such teaching to the content of the examples.

Pipe Dope Removal

It is noted that COPPER SUPREME SPECIAL BLEND (BESTOLIFE) was used as the pipe dope in the examples and the experiments partly because this pipe dope is particularly difficult to remove from surfaces. However, the selection of COPPER SUPREME SPECIAL BLEND is provided to facilitate description, and the present description's focus on such use should not be deemed limiting of the proposed concepts and teachings. The proposed compositions and methods are also applicable to pipe dopes employing other additives, as well as to other unwanted solids and particulates generally. Other possible pipe dopes include 3010 ULTRA (BESTOLIFE) and 220 COPPER SEAL (Balmar, LLC).

For these experiments, about 1.5 g of pipe dope was coated on the outside of a scored CHAN MODEL 35 rotor (with the bottom hole closed). The coated rotor was then submerged in 160 mL of one of the example compositions, and rotated at 200 RPM at a temperature of 100° F. for 20 minutes using a CHAN 35 viscometer rotor sleeve. At pre-determined time points, the removal of pipe dope was visibly observed, and the rotor was weighed to determine the extent of pipe dope removed. A composition was considered to have adequately removed the pipe dope where the extent of pipe dope removed rivaled that achieved by xylene (which can effectively remove pipe dope, but has a poor environmental profile).

The rotor was weighed at each time point by removing the rotor from the composition and allowing the composition to drip off for 2 minutes. The bottom was then gently wiped using a paper towel to remove any drops hanging from the rotor. The rotor was removed from the CHAN 35 sleeve and weighed upside down on a balance.

For these experiments, several compositions were studied. As an example of a composition within a disclosed embodiment, TERRAVIS M5 surfactant was added to MLB 161-11-02 solvent to create a composition containing 5 vol % alcohol ethoxylate and 95 vol % citrus terpene hydrocarbons. The composition removed approximately 80 wt % of the pipe dope within 10 minutes, and ultimately accomplished approximately 90 wt % removal. Visual inspection revealed that the pipe dope had been lifted from the surface of the substrate, leaving a clean surface without filming.

A first comparative example was prepared as a composition containing 100 vol % A026 (xylene) solvent with no surfactant. The solvent acted rapidly on the pipe dope, removing over 60 wt % of the pipe dope within the first 5 minutes, and ultimately removing approximately 90 wt % of the applied pipe dope. However, as apparent from visual inspection of the sample, a film of pipe dope remained on the sample even after 20 minutes.

As a second comparative example, a composition containing 100 vol % MLB 161-11-02 solvent (with no surfactant) was studied. The solvent removed approximately 60 wt % of the pipe dope within the first 10 minutes, but achieved limited results thereafter. Residual pipe dope was clearly observed on the surface of the substrate even after 20 minutes of treatment.

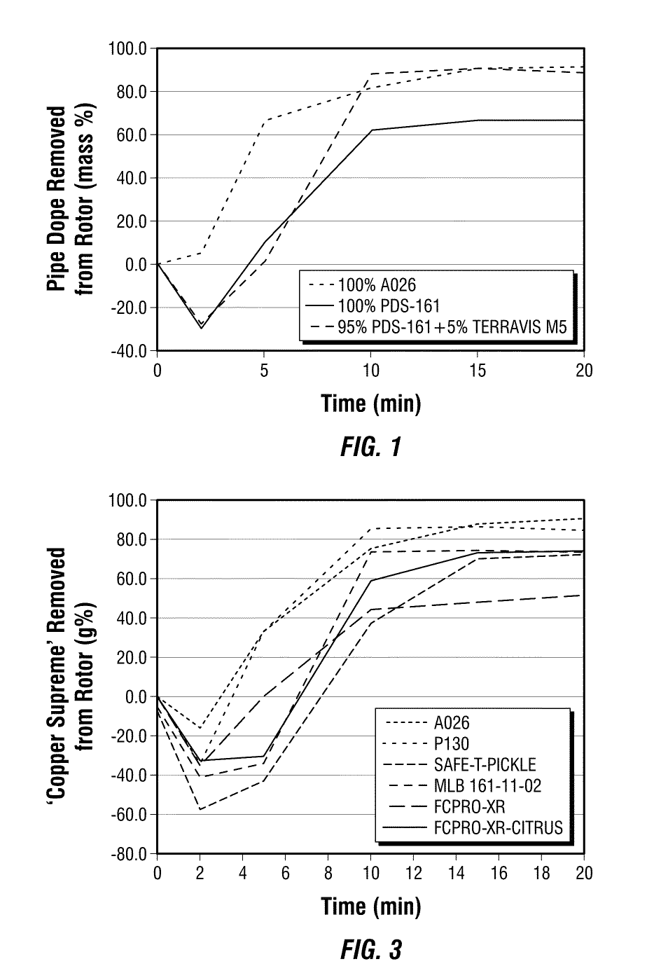

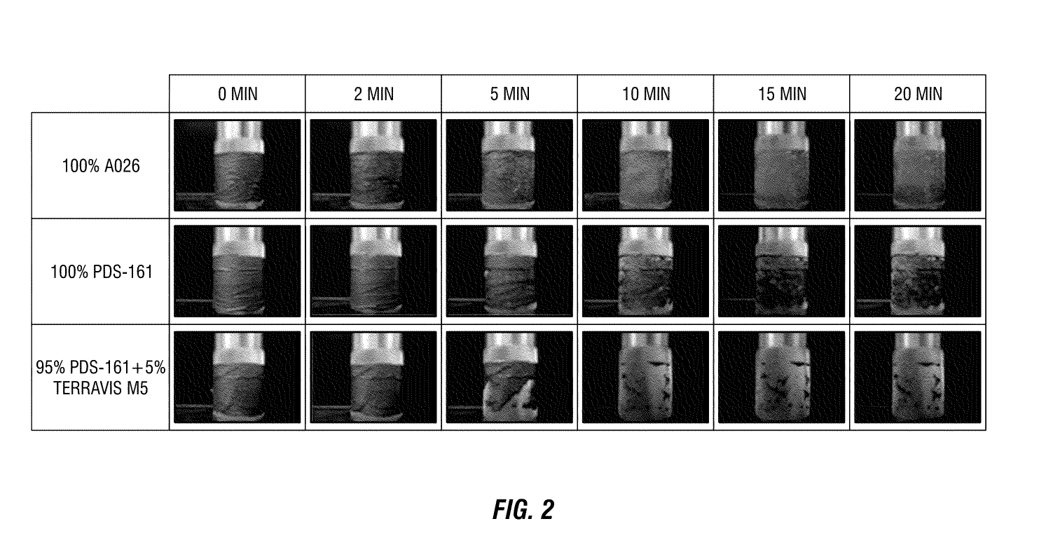

The results of the weight percent of pipe dope removed for the above example and comparative examples are set forth in FIG. 1, and the results of visual observation are presented in FIG. 2. As shown in FIGS. 1 and 2, the composition containing 5 vol % alcohol ethoxylate and 95 vol % citrus terpene hydrocarbons removed at least as much pipe dope as xylene.

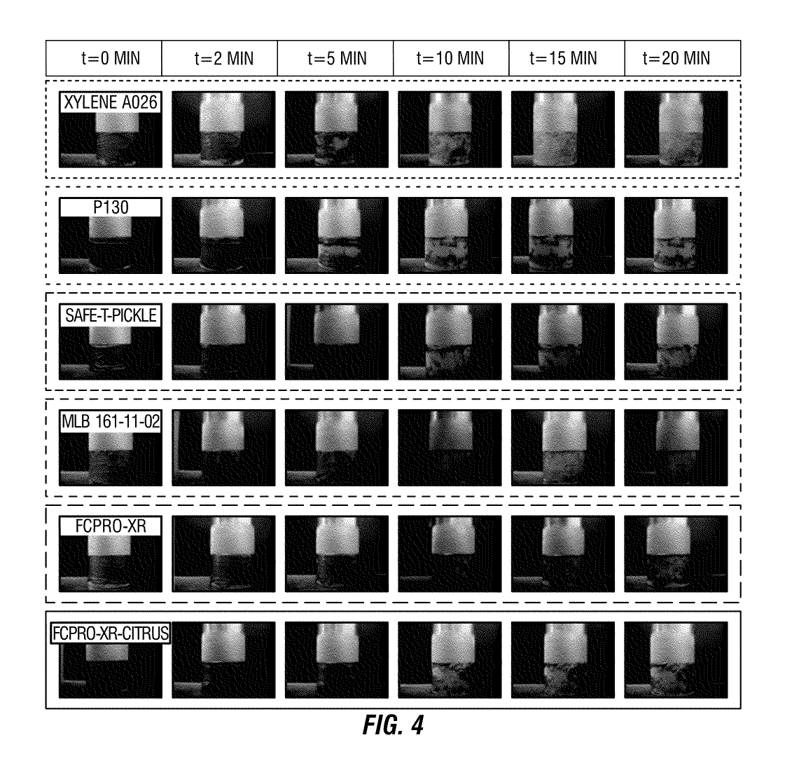

Additional comparative examples were studied to demonstrate the effect of using 100 vol % solvent or 100 vol % surfactant to treat the pipe dope without blending solvent and surfactant. The results are set forth in FIGS. 3 and 4. Although A026 and P130 achieved between 80 and 90 wt % removal after 20 minutes of treatment, each of the treated rotors exhibited notable amounts of filming. The other comparative examples removed approximately 70 wt % or less of the pipe dope after 20 minutes of treatment.

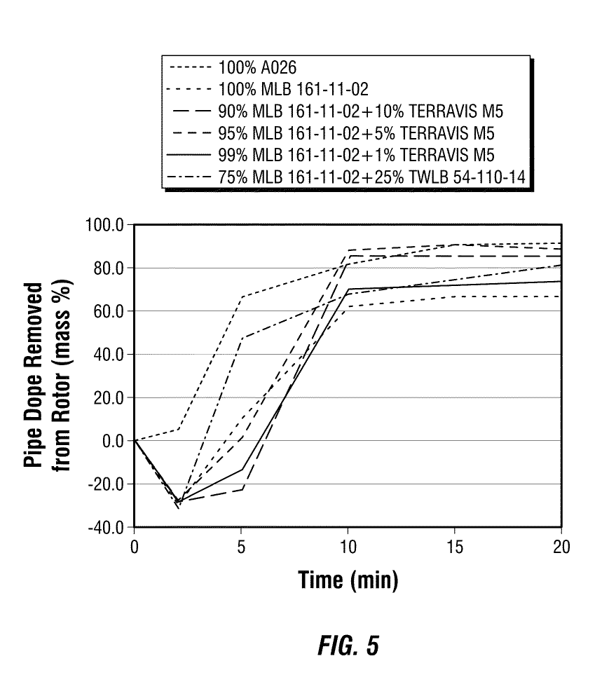

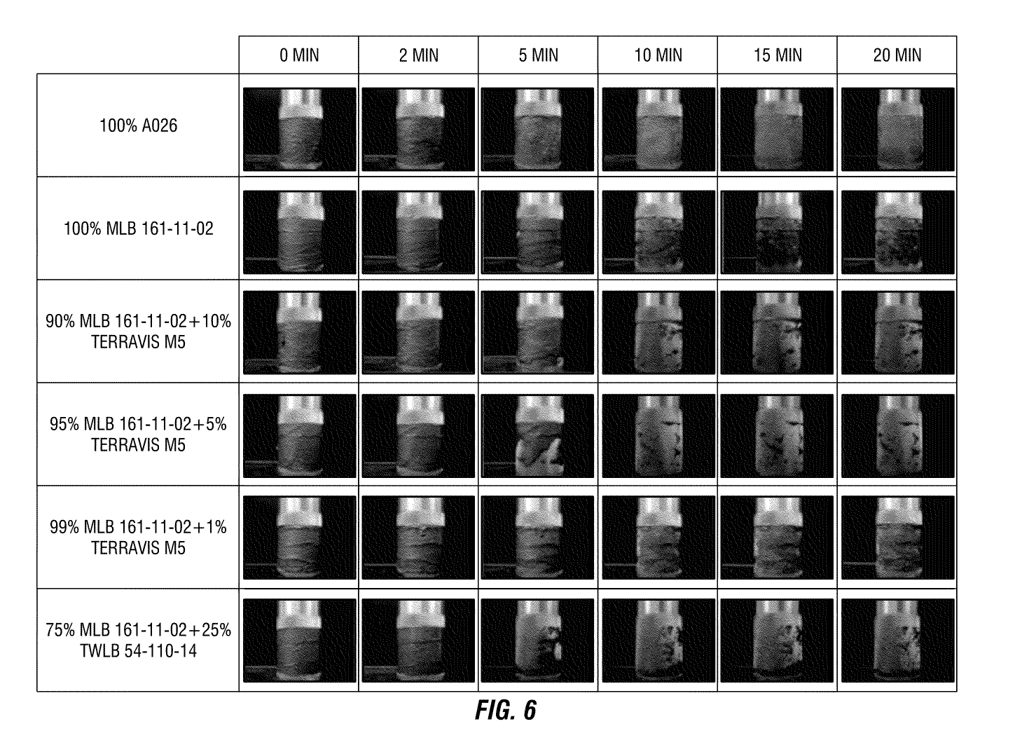

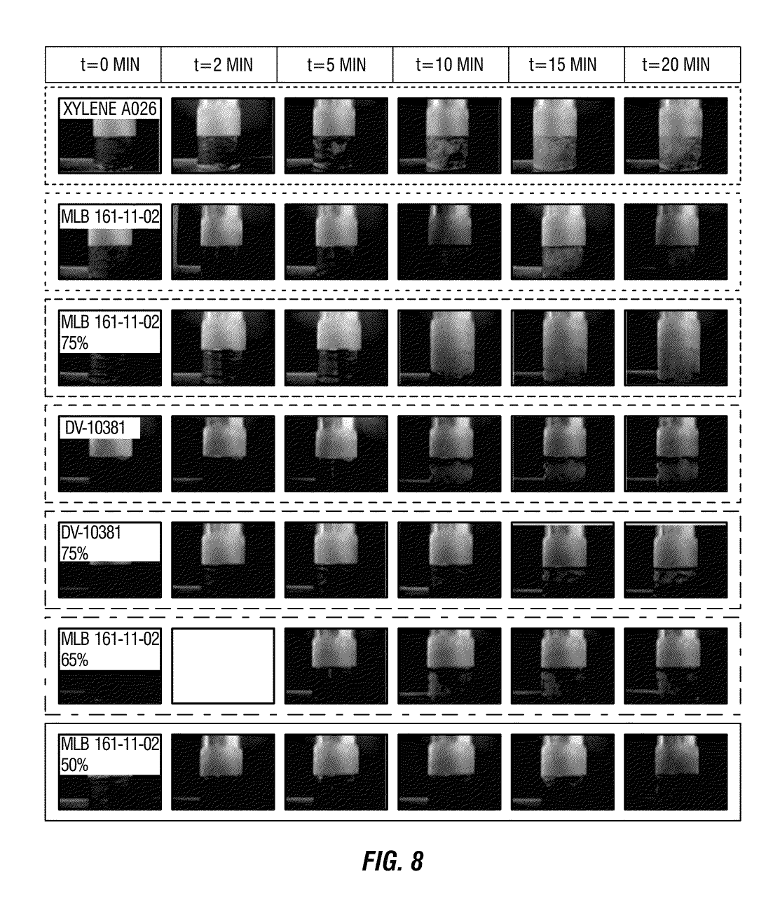

Additional studies tracked the effect of varying the concentration of surfactant in the treatment composition. The results are set forth in FIGS. 5-8. As examples of compositions within a disclosed embodiment, TERRAVIS M5 surfactant was added to MLB 161-11-02 solvent in varying concentrations to create compositions containing 1 vol %, 5 vol %, and 10 vol % alcohol ethoxylate in citrus terpene hydrocarbons. Even with the addition of just 1 vol % TERRAVIS M5, treatment resulted in the improved removal of pipe dope with respect to use of the solvent alone. The compositions comprising 5 vol % and 10 vol % of TERRAVIS M5 removed over 80 wt % of the pipe dope in under 10 minutes, and ultimately removed 85-90 wt % of the pipe dope by lifting the pipe dope from the rotor without leaving a film.

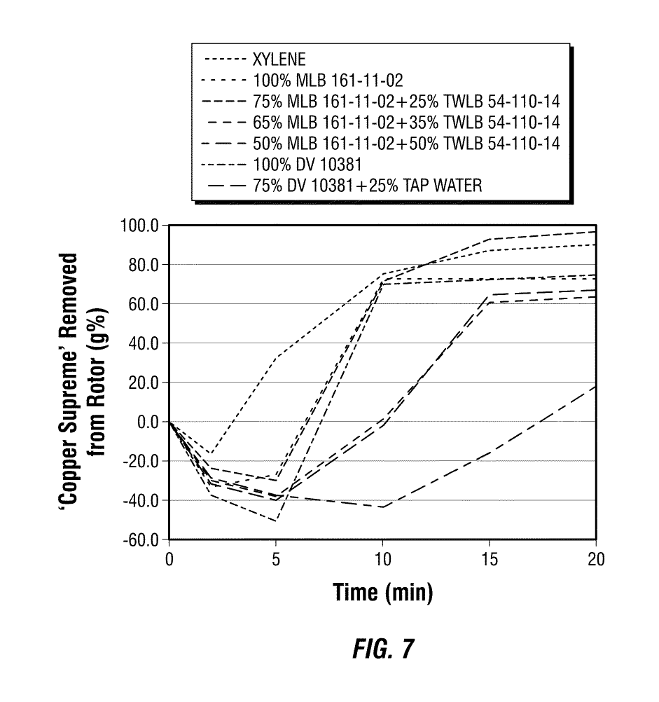

As additional comparative examples, TWLB 54-110-14 was added to MLB 161-11-02 in varying concentrations to create compositions containing 25 vol %, 35 vol %, and 50 vol % surfactant in citrus terpene hydrocarbons. As seen in FIG. 7, the composition containing 50 vol % surfactant removed less than 20 wt % pipe dope over the course of the treatment. The composition containing 35 vol % solvent performed similarly to a composition containing 75 vol % commercially available DV 10381 solvent and 25 vol % water, removing less than 70 wt % of the pipe dope. However, the composition containing 25 wt % surfactant removed more pipe dope than the MLB 161-11-02 solvent alone, and even more than the xylene solvent.

Stability of Solvent Mixtures

In a first experiment, the short-term stability of solvent mixtures was observed at room temperature. As an example within a disclosed embodiment, 10 vol % TERRAVIS M5 was mixed with 90 vol % MLB 161-11-02. After one hour, the sample remained transparent and no phase separation was observed between the solvent and the surfactant. No visual distinction was observed between the example and a 100 vol % solution of MLB 161-11-02. As a comparative example, 10 vol % TWLB 54-110-14 was mixed with 90 vol % MLB 161-11-02. Immediate phase separation was observed, and the solvent mixture appeared opaque. After one hour, the solvent and surfactant were observable as distinct phases.

In a second experiment, the long-term stability of solvent mixtures was observed. One example within a disclosed embodiment included 10 vol % TERRAVIS M5 and 90 vol % MLB 161-11-02, and another example included 5 vol % TERRAVIS M5 and 95 vol % MLB 161-11-02. The stability of the samples was observed at room temperature and at 150° F. after the passage of 4 days. Each of the samples remained transparent, and no phase separation was observed.

Solvent/Surfactant
A026 (Schlumberger)

100 wt % xylenes
DV-10381 (Solvay):

20-30 wt % proprietary emulsifier blend

35-45 wt % proprietary solvents

3-7 wt % proprietary surfactant

27-32 wt % water

FC PRO XYLENE REPLACEMENT (Florida Chemical):

100 wt % pine terpene
FC PRO XYLENE REPLACEMENT—CITRUS (Florida Chemical):

100 wt % citrus terpene hydrocarbons
MLB 161-11-02 (CESI):

70-100 wt % citrus terpene hydrocarbons
P130 (Schlumberger):

100 wt % d-limonene
SAFE-T-PICKLE (M-I SWACO):

30-60 wt % petroleum distillates, hydrotreated light

30-60 wt % terpene
TERRAVIS M5 (Sasol Chemicals (USA) LLC):

100 wt % alcohol ethoxylate
TWLB 54-110-14 (CESI):

water and alcohol ethoxylates

Pipe Dope
COPPER SUPREME SPECIAL BLEND (BESTOLIFE):

40-70 wt % lubricating greases

7-13 wt % copper

1-5 wt % lime

Although only a few example embodiments have been described in detail above, those skilled in the art will readily appreciate that many modifications are possible in the example embodiments without materially departing from the disclosed COMPOSITION AND METHOD FOR REMOVING PIPE DOPE. Accordingly, all such modifications are intended to be included within the scope of this disclosure as defined in the following claims.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112(f) for any limitations of any of the claims herein, except for those in which the claim expressly uses the words “means for” together with an associated function.

What is claimed is:

1. A method of substantially removing pipe dope from a wellbore surface, the method comprising:
contacting the wellbore surface with an effective amount of a composition comprising:
70 to 99 vol % citrus terpene hydrocarbons, and
1 to 30 vol % of an alcohol ethoxylate represented by the formula
R(C₂H₄O)ₙOH, wherein R is a branched or linear alkyl chain having from 12 to 15 carbons, and n is from 3 to 14; and
circulating the composition with respect to the wellbore surface so that at least a portion of the pipe dope detaches from the surface and is dispersed in the composition.

2. The method according to claim 1, wherein the citrus terpene hydrocarbons are d-limonene.

3. The method according to claim 1, wherein the composition comprises:
80 to 98 vol % of the citrus terpene hydrocarbons; and
2 to 20 vol % of the alcohol ethoxylate.

4. The method according to claim 1, wherein the composition comprises:
90 to 95 vol % of the citrus terpene hydrocarbons; and
5 to 10 vol % of the alcohol ethoxylate.

5. The method according to claim 1, wherein the pipe dope comprises copper.

6. The method according to claim 1, wherein the circulating generates turbulent flow.

7. The method according to claim 1, comprising:
injecting the composition into a tubing of a wellbore; and
circulating the composition down the tubing.

8. The method according to claim 7, wherein the circulating removes at least a portion of the pipe dope from a surface of the tubing.

9. The method according to claim 7, comprising:
circulating the composition up an annulus between the tubing and a casing; and
withdrawing composition having the pipe dope dispersed therein from the wellbore surface.

10. The method according to claim 9, wherein the circulating removes at least a portion of the pipe dope from a surface of the casing.

11. A composition comprising:
70 to 99 vol % citrus terpene hydrocarbons; and
1 to 30 vol % of an alcohol ethoxylate represented by the formula R(C₂H₄O)ₙOH, wherein R is a branched or linear alkyl chain having from 12 to 15 carbons, and n is from 3 to 14.

12. The composition according to claim 11, wherein the citrus terpene hydrocarbons are d-limonene.

13. The composition according to claim 11, wherein the alcohol ethoxylate is fully soluble in the citrus terpene hydrocarbons.

14. The method according to claim 11, wherein the composition comprises:
80 to 98 vol % of the citrus terpene hydrocarbons; and
2 to 20 vol % of the alcohol ethoxylate.

15. The method according to claim 11, wherein the composition comprises:
90 to 95 vol % of the citrus terpene hydrocarbons; and
5 to 10 vol % of the alcohol ethoxylate.
